(19) United States
(12) Patent Application Publication
(10) Pub. No.: US 2018/0143816 A1
(43) Pub. Date: May 24, 2018

(54) REDUCING LATENCY BETWEEN CLICKING MEDIA CONTENT AND LANDING ON A RESULTING APPLICATION INSTALLATION PAGE

(71) Applicant: Google Inc., Mountain View, CA (US)

(72) Inventor: Aurash Mahbod, San Jose, CA (US)

(21) Appl. No.: 15/356,263

(22) Filed: Nov. 18, 2016

(51) Int. Cl. G06F 9/445; H04L 29/08; H04L 29/06

(52) U.S. Cl. CPC G06F 8/61; H04L 67/34; H04L 63/0861; H04L 63/083; H04L 63/0428

(57) ABSTRACT

Method and apparatus for coordinating between a media content serving platform and an application distribution platform are provided to reduce the latency between the time the user clicks a media item and the time the media item lands on an application installation page which would allow the user to download an application associated with the media item. The media content serving platform prepares application installation information of an application associated with the media item and transmits the application installation information to the application distribution platform. The application distribution platform makes the application installation information immediately available for the user device to download the application from an application store. The speed of operation of the user device is improved by making the application immediately available for downloading at the application store.

### BACKGROUND

Online media contents have been provided on web pages of mobile devices to entice mobile device users to install applications that would allow the users to purchase, lease or use products or services. A clickable link may be provided in a given area of media content to allow a mobile device user to install an application associated with the online media content. In the current state of the art, however, the mobile device user may have to wait for an appreciable amount of time, for example, on the order of several seconds in some instances, between the time of clicking the online media content on the mobile device and the time of landing the media content on a resulting application installation page which would allow the user to download the application.

### BRIEF SUMMARY

According to an embodiment of the disclosed subject matter, a method of providing an application in response to selection of a media item on a user device includes: prior to receiving a request from the user device to download an application, preparing, by a media content serving platform, application installation information of an application associated with the media item, the application installation information comprising information selected from the group consisting of an application installation page and application installation metadata; and transmitting, by the media content serving platform, the application installation information to an application distribution platform, to cause the application distribution platform to make the application installation information available for the user device to download the application prior to receiving the request from the user device to download the application.

According to an embodiment of the disclosed subject matter, an apparatus for providing an application in response to selection of a media item on a user device includes a memory and a processor communicably coupled to the memory. The processor is configured to execute instructions to: prepare application installation information of an application associated with the media item, the application installation information comprising information selected from the group consisting of an application installation page and application installation metadata, prior to receiving a request from the user device to download an application; and transmit the application installation information to an application distribution platform, to cause the application distribution platform to make the application installation information available for the user device to download the application prior to receiving the request from the user device to download the application.

According to an embodiment of the disclosed subject matter, an apparatus for providing an application in response to selection of a media item on a user device includes an application distribution platform and a media content serving platform communicably coupled to the application distribution platform. The media content serving platform is configured to: prepare application installation information of an application associated with the media item, the application installation information comprising information selected from the group consisting of an application installation page and application installation metadata, prior to receiving a request from the user device to download an application; and transmit the application installation information to the application distribution platform, to cause the application distribution platform to make the application installation information available for the user device to download the application prior to receiving the request from the user device to download the application.

According to an embodiment of the disclosed subject matter, an apparatus for providing an application in response to selection of a media item on a user device includes: means for preparing application installation information of an application associated with the media item, the application installation information comprising information selected from the group consisting of an application installation page and application installation metadata, prior to receiving a request from the user device to download an application; and means for transmitting the application installation information to an application distribution platform, to cause the application distribution platform to make the application installation information available for the user device to download the application prior to receiving the request from the user device to download the application.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example of a network configuration suitable for implementations of the presently disclosed subject matter.

FIG. 2 shows an example of a computer suitable for implementations of the presently disclosed subject matter.

FIG. 3 shows an example of a process of coordinating between a media content serving platform and an application distribution platform to reduce the latency between the time the user clicks an online advertisement and the time the advertisement lands on an application installation page according to an implementation of the disclosed subject matter.

FIG. 4 shows an example of a process which includes pre-caching of application installation pages of online advertisements based on probabilities that users will download the advertisements within a given timeframe according to an implementation of the disclosed subject matter.

FIG. 5 shows an example of a process which includes building a signaling mechanism to signal an application distribution platform to receive application installation information according to an implementation of the disclosed subject matter.

FIG. 6 shows an example of a process which includes building a serving mechanism to create a cryptographically signed bundle of application installation metadata according to an implementation of the disclosed subject matter.

FIG. 7A shows an example of a mobile device displaying a web page with an online advertisement.

FIG. 7B shows an example of the mobile device of FIG. 7A displaying an application store that includes an application installation icon for an application ready for downloading.

FIG. 7C shows an example of the mobile device of FIGS. 7A-B during downloading of the application.

FIG. 8A shows an example of a mobile device that is running an application, such as a game, that hosts an online advertisement.

FIG. 8B shows an example of the mobile device of FIG. 8A displaying an application store that includes an application installation icon for an application ready for downloading.

FIG. 8C shows an example of the mobile device of FIGS. 8A-B during downloading of the application.

### DETAILED DESCRIPTION

In conventional online advertising, a large amount of time delay or latency may exist between the time of clicking an online advertisement on a web page by a user of a mobile device and landing the advertisement on a resulting application installation page which would allow the user to download an application associated with the online advertisement. In some instances, there may be multiple seconds of latency between clicking the online advertisement and landing the online advertisement on the resulting application installation page, thus producing undesirable user experiences and making the user reluctant to install applications associated with online advertisements in the future. Moreover, the user may not be able to access or use other applications on the mobile device while waiting for the advertisement to land on the application installation page which would allow the user to initiate downloading of the application, thus slowing the speed of operation of the mobile device.

The presently-disclosed subject matter relates to methods and apparatuses for coordinating between a media content serving platform and an application distribution platform to reduce the latency between the time the user clicks an online advertisement and the time the advertisement lands on an application installation page which would allow the user to download an application associated with the advertisement. The media content serving platform, which may be an advertisement serving platform, prepares application installation information of an application associated with an advertisement based on one or more events, examples of which are described in further detail below. The media content serving platform then transmits the application installation information of the application to the application distribution platform. The application distribution platform makes the application installation information immediately available for the user device to download the application from an application store. In one implementation, the media content serving platform determines probabilities of consumer interest in certain online advertisements and directs the application distribution platform to pre-cache the installation pages of those applications. In another implementation, the media content serving platform builds a signaling mechanism which allows the application distribution platform to pre-fetch application installation information for an application associated with an advertisement which is hosted in another application that is being run on the user device. In another implementation, the media content serving platform builds a serving mechanism by creating a cryptographically signed bundle that includes application installation metadata. The media content serving platform transmits the bundle to the application distribution platform, which, upon receiving the cryptographically signed bundle, unpacks the bundle and makes application installation pages corresponding to the application installation metadata available to the user device prior to receiving a user request for downloading. By making the application immediately available at the application store for downloading onto a user device, the speed of operation of the user device is improved.

As used herein, a “user device” is any device in which one or more applications may be run, including but not limited to a mobile device such as a smartphone, a smartwatch, a tablet, or the like, or a laptop computer, a desktop computer, or the like. As used herein, an “application” is a computer program or software code with an interface, such as a user interface, which enables a user to accomplish a task on a user device. The user interface for an application may include an icon or soft key on a touchscreen, a physical key or button, a stylus, a voice input, or any other type of user input that allows the user to interact with the application. An application may be developed by one or more software developers. As used herein, an “application store” is an online portal through which computer programs are made available for download by users of mobile devices. Applications may be purchased or downloaded free of charge under restricted or unrestricted licenses. An application that is made available in an application store may or may not be developed by the same entity as the entity that owns or operates the application store.

As used herein, a “platform” is a system that includes a hardware device or architecture, an operating system, or a combination thereof, on which one or more applications, programs or processes may run. As used herein, an “application distribution platform” is a platform that distributes one or more applications to one or more user devices through wired or wireless connections. An application distribution platform may host an application store which makes applications available for downloading by the user device, for example, by displaying the applications to be installed as icons on an application installation page. As used herein, a “media content serving platform” is a platform that serves online media contents such as advertisements, at least some of which may include clickable areas or links to one or more applications. As used herein, a “software development kit” (“SDK”) includes a set of software development tools that allows the creation of applications for a certain software package, software framework, hardware platform, computer system, video game console, operating system, or another development platform. To enrich applications with functionalities such as advertisements, push notifications, or the like, application developers may implement specific SDKs for such functionalities.

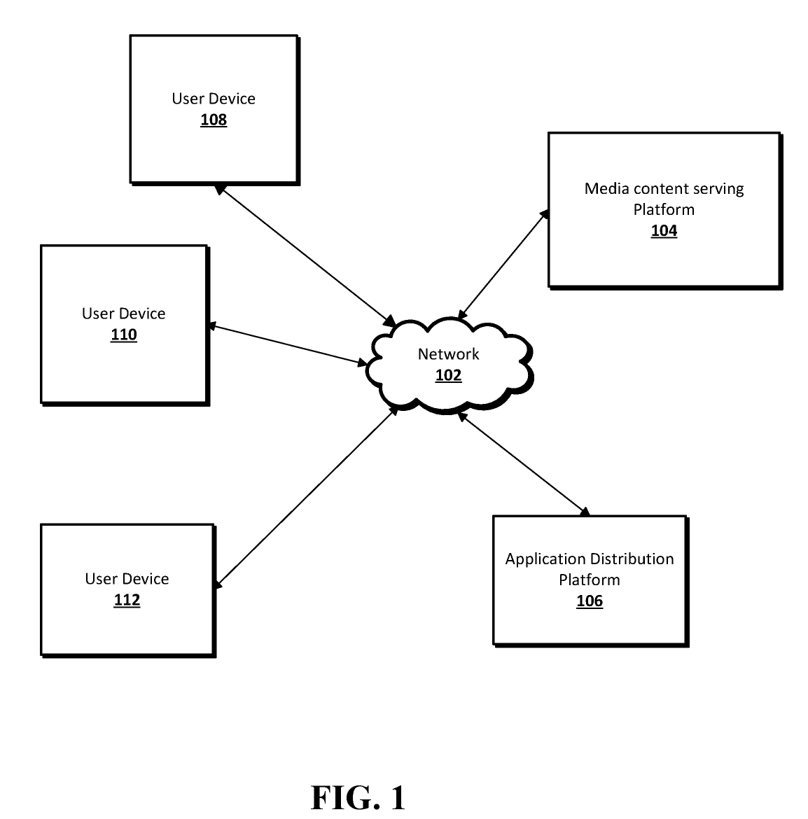

FIG. 1 shows an example of a network configuration suitable for implementations of the presently disclosed subject matter. In FIG. 1, a network 102 is provided which connects a media content serving platform 104, an application distribution platform 106, and user devices 108, 110 and 112. The media content serving platform 104 may include one or more servers, mainframe computers, desktop computers, laptop computers, mobile computers such as smart phones, tablet computing devices, or the like. Likewise, the application distribution platform 106 may include one or more servers, mainframe computers, desktop computers, laptop computers, mobile computers such as smart phones, tablet computing devices, or the like. Although FIG. 1 shows three user devices 108, 110 and 112, it will be appreciated that many user devices of various types may be connected to the network 102. In some implementations, any of the user devices 108, 110 and 112 may be a mobile device that communicates with the network 102 through a wireless connection, such as a Wi-Fi connection, a Bluetooth connection, a cellular telephone connection, a satellite connection, or the like. In some implementations, any of the user devices 108, 110 and 112 may be a device that communicates with the network 102 through a wired connection, for example, an Ethernet connection, a cable connection, an optical fiber connection, or the like.

The network 102 may be a personal area network (PAN), local area network (LAN), wide area network (WAN), the Internet, or any other suitable communication network or networks, and may be communicate with the media content serving platform 104, the application distribution platform 106, or any of the user devices 108, 110, and 112, through a wired or wireless connection, or a combination thereof. In some implementations, one or more of the media content serving platform 104, the application distribution platform 106, or any of the user devices 108, 110 and 112 may access the network 102 through cloud computing arrangements and services (not shown). In some implementations, security measures, such as encryption and decryption, authentication using login and password, or authentication using biometric measures, may be implemented at one or more of the platforms or devices. Various network arrangements may be implemented within the scope of the disclosed subject matter. Examples of processes described below may be implemented in various network configurations different from the configuration shown in FIG. 1 and described above.

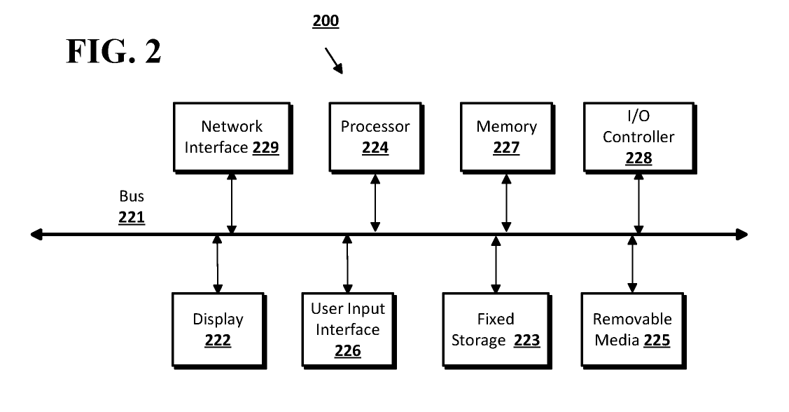

FIG. 2 shows an example of a computer 200 suitable for implementations of the presently disclosed subject matter. The example of the computer as shown in FIG. 2 may be implemented as the media content serving platform 104, the application distribution platform 106, or any of the user devices 108, 110 and 112 as shown in FIG. 1. In FIG. 2, the computer 200 includes a bus 221 which interconnects major components of the computer 200, such as a central processor 224, a memory 227 (typically RAM, but which may also include ROM, flash memory, or the like), an input/output (I/O) controller 228, a user display 222, such as a display screen via a display adapter, a user input interface 226, which may include one or more controllers and associated user input devices such as a keyboard, mouse, or the like, and may be closely coupled to the I/O controller 228, fixed storage 223, such as a hard drive, flash storage, Fiber Channel network, SAN device, SCSI device, or the like, and a removable media component 225 operative to control and receive an optical disk, flash drive, or the like. Some of the components may be physically integrated with one another in some implementations. For example, in a mobile device, the display and the user input device may be integrated as a touchscreen.

The bus 221 allows data communication between the central processor 224 and the memory 227, which may include read-only memory (ROM) or flash memory (neither shown), and random access memory (RAM) (not shown), as previously noted. The RAM is generally the main memory into which the operating system and application programs are typically loaded. The ROM or flash memory may contain, among other code, the Basic Input-Output System (BIOS) which controls basic hardware operation such as the interaction with peripheral components. Applications resident within the computer 200 may be stored on and accessed via a computer readable medium, such as a hard disk drive (e.g., fixed storage 223), an optical drive, floppy disk, or other storage media such as removable media 225, or in a memory such as a flash or non-volatile memory.

The fixed storage 223 may be integral with the computer 200 or may be separate and accessed through other interfaces. A network interface 229 may provide a direct connection to a remote server via a wired or wireless telephone link, a cable link, an optical fiber link, a satellite link, or the like, to the Internet via an Internet service provider (ISP), or a direct connection to a remote server via a direct network link to the Internet via a POP (point of presence) or other technique. The network interface 229 may provide such connection using wireless techniques, including digital cellular telephone connection, Cellular Digital Packet Data (CDPD) connection, digital satellite data connection or the like. The network interface 229 may allow the computer to communicate with other computers via one or more local-area, wide-area, or other networks, as shown in FIG. 1.

Many other devices or components (not shown) may be connected in a similar manner (e.g., document scanners, digital cameras and so on). Conversely, all of the components shown in FIG. 2 need not be present to practice the presently disclosed subject matter. For example, in embodiments in which the user device 108, 110 or 112 is a mobile device, the computer which is implemented in the mobile device may not include a floppy disk drive, a hard disk drive, or an optical drive. Instead of a keyboard and a mouse, user inputs on a mobile device may be achieved via a touchscreen. Moreover, the components can be interconnected in different ways from that shown. The operation of a computer such as that shown in FIG. 2 is readily known in the art and is not discussed in detail in this application. Code to implement the presently disclosed subject matter can be stored in computer-readable storage media such as one or more of the memory 227, fixed storage 223, removable media 225, or at a remote storage location, for example, a cloud storage.

More generally, various implementations of the presently disclosed subject matter may include or be implemented in the form of computer-implemented processes and apparatuses for practicing those processes. The processes also may be implemented in the form of a computer program product having computer program code containing instructions implemented in non-transitory and/or tangible media, such as floppy diskettes, CD-ROMs, hard drives, USB (universal serial bus) drives, flash memory, or any other machine readable storage medium, wherein, when the computer program code is loaded into and executed by a computer, the computer becomes an apparatus for practicing implementations of the disclosed subject matter. The processes also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. The processes may be implemented by using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

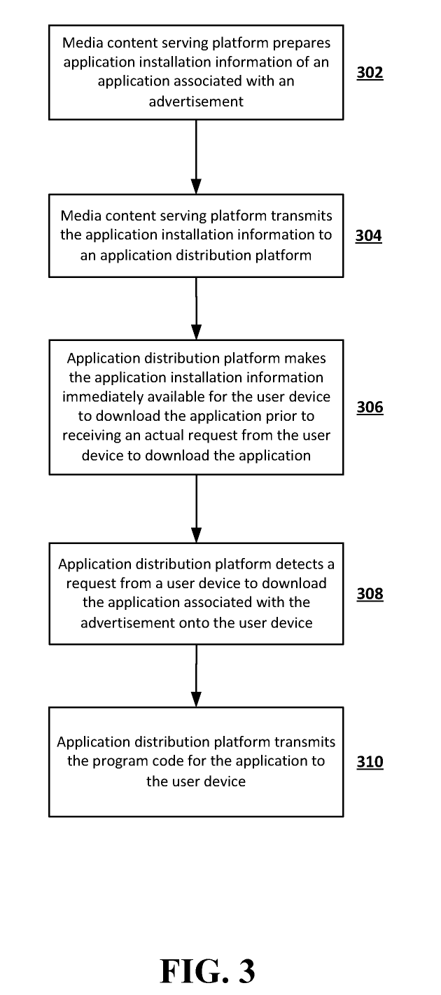

FIG. 3 shows an example of a process of coordinating between a media content serving platform and an application distribution platform according to an implementation of the disclosed subject matter. Such a process reduces the latency between the time the user clicks an online advertisement and the time the advertisement lands on an application installation page which would allow the user to download an application associated with the advertisement. In block 302, the media content serving platform prepares application installation information of an application associated with an advertisement, examples of which are described in further detail below. In some implementations, the application installation information may include a pre-cached application installation page. In some implementations, in addition or as an alternative to the application installation page, the application installation information may include metadata for installation of the application associated with the advertisement.

In block 304, the media content serving platform transmits the application installation information of the application associated with the advertisement to an application distribution platform. In block 306, the application distribution platform, which may host an application store, for example, makes the application installation information immediately available for the user device to download the application from the application store, prior to receiving an actual request from the user device to download the application. In block 308, the application distribution platform detects a request from a user device to download the application associated with the advertisement onto the user device. For example, the user of the device may request downloading of the application by clicking a certain area of the advertisement, a hyperlink, or the like, on a touchscreen of a mobile device, or by other methods of input, such as a voice command. In response to the request from the user device, the application distribution platform transmits the program code for the application to the user device in block 310. The user device may download the program code for the application from the application distribution platform, through a wired or wireless connection, in a network arrangement such as the one shown in FIG. 1 and described above, or in various other network arrangements, for example, through a cloud computing service.

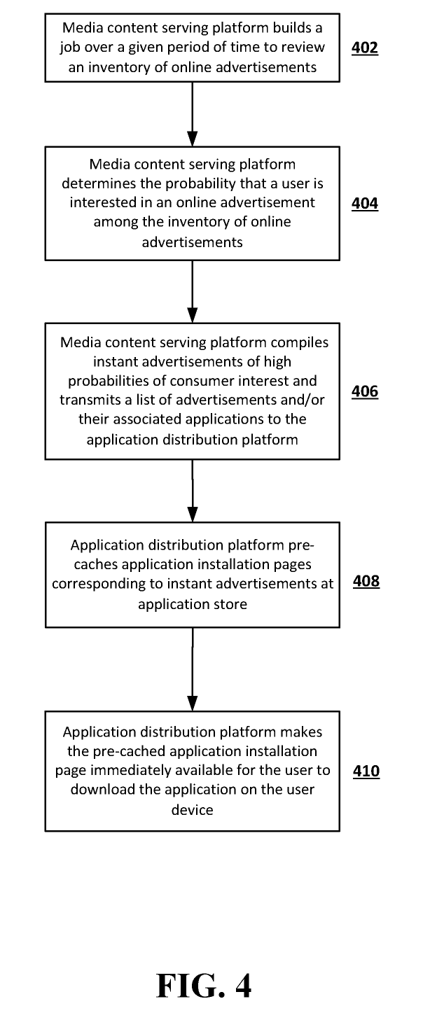

FIG. 4 shows an example of a process which includes pre-caching of application installation pages of online advertisements based on the probability that a user will download the advertisements within a given timeframe according to an implementation of the disclosed subject matter. In block 402, the media content serving platform builds a job over a given period of time to review an inventory of online advertisements which includes application installation functionalities that are available in a given market, geographic region, user demographic, or the like. The job may be built periodically, for example, on a daily basis. In block 404, the media content serving platform determines the probability that a user would be interested in an online advertisement among the inventory of online advertisements over the given period of time. In some implementations, the media content serving platform may compile statistics indicating consumer interest for a given advertisement among the inventory of advertisements in a given market, geographic region, demographic, or the like, and determines a probability that a user is likely to be interested in the advertisement, as shown in block 404. In addition or as an alternative, the probability that a user will download an advertised application in the online advertisement inventory may be determined based on a prior usage pattern, for example, based on the types of applications that the user previously downloaded. In some implementations, the probability that a user will download an advertised application may be based on one or more other factors, such as historical preferences of a particular user based on a user profile for certain types of applications or software providers, preferences of users in similar demographics or geographic regions for certain types of applications or software providers, or the like.

In various implementations, the probability of consumer interest may be the probability that a particular user would be interested in an advertisement, or the probability that a group of similar users in a given demographic, geographic region, or the like would be interested in the advertisement. Based on the probability of consumer interest in each advertisement in the inventory, the media content serving platform compiles a list of “instant” advertisements with high probabilities of consumer interest and transmits a list of applications associated with the instant advertisements to the application distribution platform in block 406. In some implementations, among a large inventory of online advertisements served by the media content serving platform, only those advertisements that are determined to have probabilities of consumer interest above a threshold probability level, for example, 80%, may be placed on a list of instant advertisements whose associated applications are to be pre-cached.

Upon receiving the list of instant advertisements, the application distribution platform pre-stores (e.g., pre-caches) the application installation pages corresponding to the instant advertisements at the application store in block 408, prior to receiving an actual request from the user device to download one of the applications. When a user clicks an online advertisement on a web page, and that advertisement is one of the instant advertisements based on the probable level of consumer interest as determined by the media content serving platform, the application distribution platform makes the pre-cached application installation page immediately available for the user to download the application on the user device in block 410. Because the installation page of the application was pre-cached in the application store prior to the request by the user to download the application, the downloading of the application may start immediately, thereby improving the speed of operation of the mobile device.

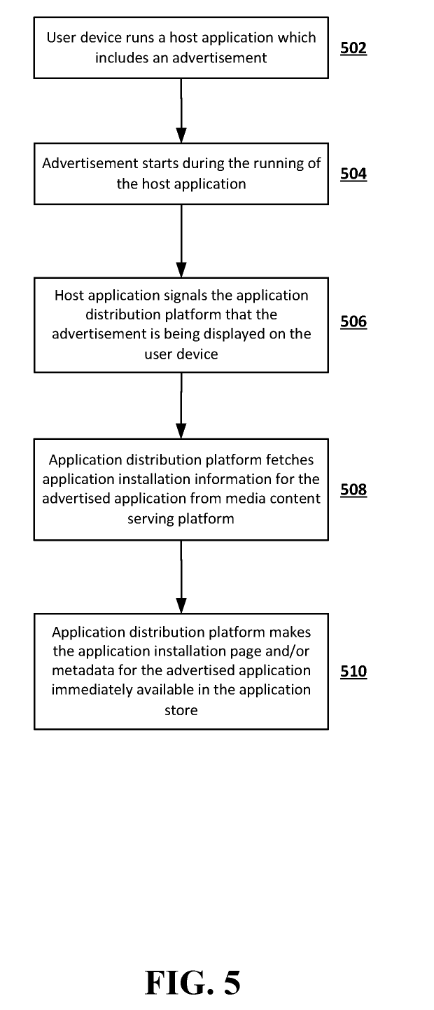

FIG. 5 shows an example of a process which includes building a signaling mechanism to signal the application distribution platform to receive or to fetch application installation information according to an implementation of the disclosed subject matter. In some implementations, a signaling mechanism may be built within an online host application which includes the online advertisement. For example, an advertisement may reside in a host application that is an online game application. At some point during the playing of the online game, the advertisement may be displayed to the user. If the user is interested in downloading the application associated with the advertisement, he or she may pause the game and click on the advertisement to start installation of the application, for example. In some implementations, one or more advertisement functionalities may be integrated in a host application by the software developer using an SDK such that one or more online advertisements may be downloaded sometime during the running of the host application. As shown in FIG. 5, the user device runs a host application which includes an advertisement in block 502. The advertisement starts at some point during the running of the host application in block 504.

When the advertisement starts during the running of the host application, an advertisement functionality in the host application may signal the application distribution platform that the advertisement is being displayed on the user device in block 506. In response to detecting a signal from the host application indicating that the advertisement is being displayed on the user device, the application distribution platform receives or fetches application installation information for the advertised application from the media content serving platform in block 508. In some implementations, the application installation information, which may include the application installation page and/or the metadata for application installation, may be fetched by the application distribution platform before the user clicks on the advertisement to download the application on the mobile device. As discussed above, the application installation information will have been compiled and stored in advance. If the user clicks the advertisement on the user device, the application distribution platform makes the application installation page and/or metadata for installing the advertised application immediately available in the application store in block 510.

The advertising entity may be the same as or different from the entity that owns or operates the application store. When the host application starts displaying an advertisement for an advertised application during the running of the host application, a signal may be transmitted to the media content serving platform to pre-fetch the installation page and/or metadata for the advertised application and load the installation page and/or metadata in the application store. Once the application store receives the signal indicating that the advertisement is being displayed on the mobile device, the application store may pre-fetch the page and/or metadata to allow the mobile device to load the corresponding advertised application immediately, thus improving the speed of operation of the mobile device.

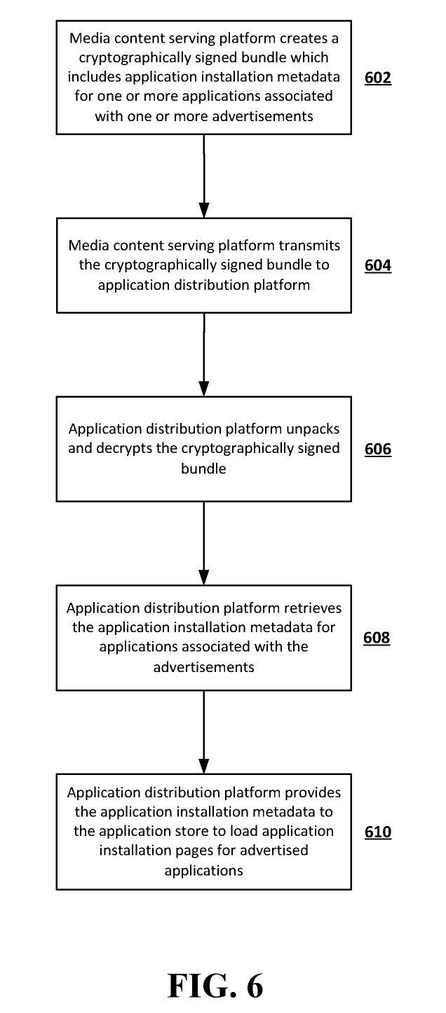

FIG. 6 shows an example of a process which includes building a serving mechanism to create a cryptographically signed bundle of application installation metadata according to an implementation of the disclosed subject matter. In block 602, the media content serving platform creates a cryptographically signed bundle which includes application installation metadata, optionally encrypted, for one or more applications associated with one or more advertisements. In some implementations, each application whose installation metadata is included the cryptographically signed bundle may be selected based on the probability of consumer interest in that application as described above, or based on the presence of the corresponding advertisement in another application, such as a game application, that is being run on the user device as described above. In block 604, the media content serving platform transmits the cryptographically signed bundle to the application distribution platform. The media content serving platform may cryptographically sign the application installation metadata such that the application distribution platform knows that the application installation metadata actually was received from a known or authorized media content serving platform and has not been tampered with. Bundling and encrypting of information such as application installation metadata may be performed in manners knowns to persons skilled in the art.

Upon receiving the cryptographically signed bundle from the media content serving platform, the application distribution platform unpacks and decrypts the bundle in block 606 to generate an unpacked and decrypted bundle, and retrieves the application installation metadata for applications associated with online advertisements from the unpacked and decrypted bundle in block 608. Unpacking and decrypting of a cryptographically signed bundle may be performed in manners known to persons skilled in the art. The application installation metadata is then provided to the application store to load application installation pages for advertised applications in block 610. When a user clicks an online advertisement, which may be provided on a web page or by a host application, such as an online game application, the application installation metadata for the online advertisement retrieved from the unpacked and decrypted bundle allows the application store to load the application installation page before the user actually clicks on the advertisement. By retrieving the metadata for the advertised application from the cryptographically signed bundle and making the application available at the application store before the user clicks on the advertisement, the speed of operation of the mobile device may be improved.

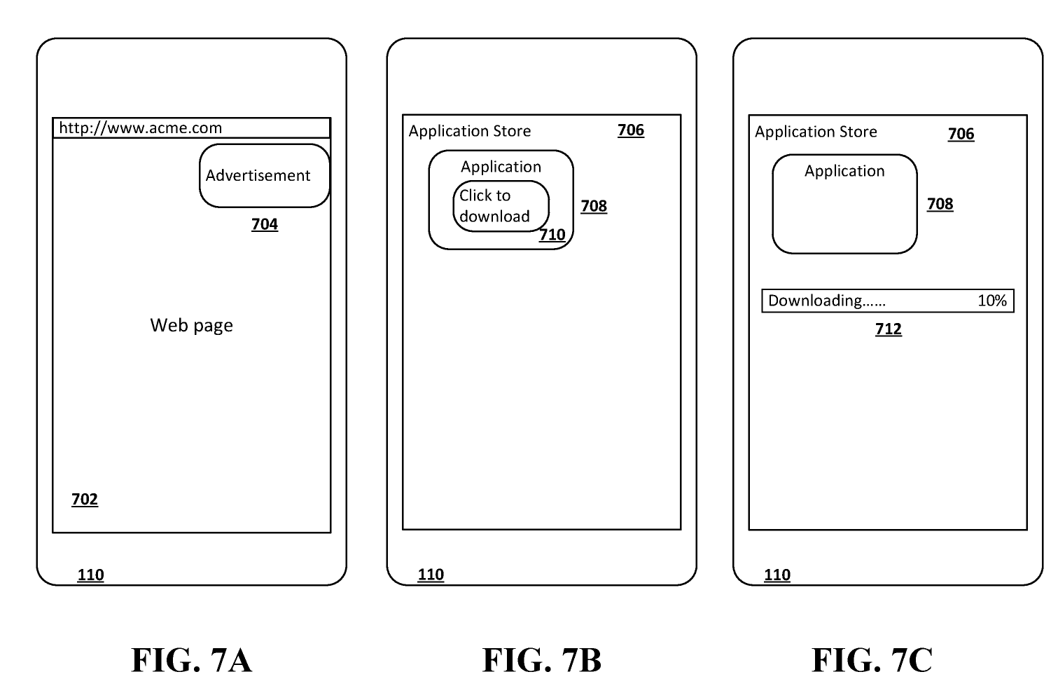

FIG. 7A shows an example of a mobile device displaying a web page with an online advertisement. In FIG. 7A, a mobile device 110 has a screen display which shows a web page 702, which includes an online advertisement 704 for an application. The online advertisement 704 may be in the form of an advertising banner, for example. The online advertisement 704 may include text, graphic, video, or a combination thereof, that occupies at least a portion of the web page 702. Some or all of the area of the online advertisement 704 may include a clickable link to the advertised application. Online advertisements may be designed and displayed in various manners known to persons skilled in the art.

When the user clicks an area of the online advertisement 704 that includes a link to the advertised application, the mobile device 110 opens an application store 706 which displays an application installation icon 708 for the advertised application, as shown in FIG. 7B. The application installation icon 708 may include a clickable link 710 which allows the user to click in order to initiate downloading of the application. In some implementations, some or all of the area of the application installation icon 708 may be clickable. In some implementations, the online advertisement 704 may include links to more than one advertised application, and icons (not shown) for more than one application may be displayed in the application store 706. After the user clicks the link 710 to download the selected application 708 in FIG. 7B, the mobile device 110 may show the process of downloading, and optionally, the percentage of the application that has been downloaded at a given time, in area 712 of the screen, as shown in FIG. 7C.

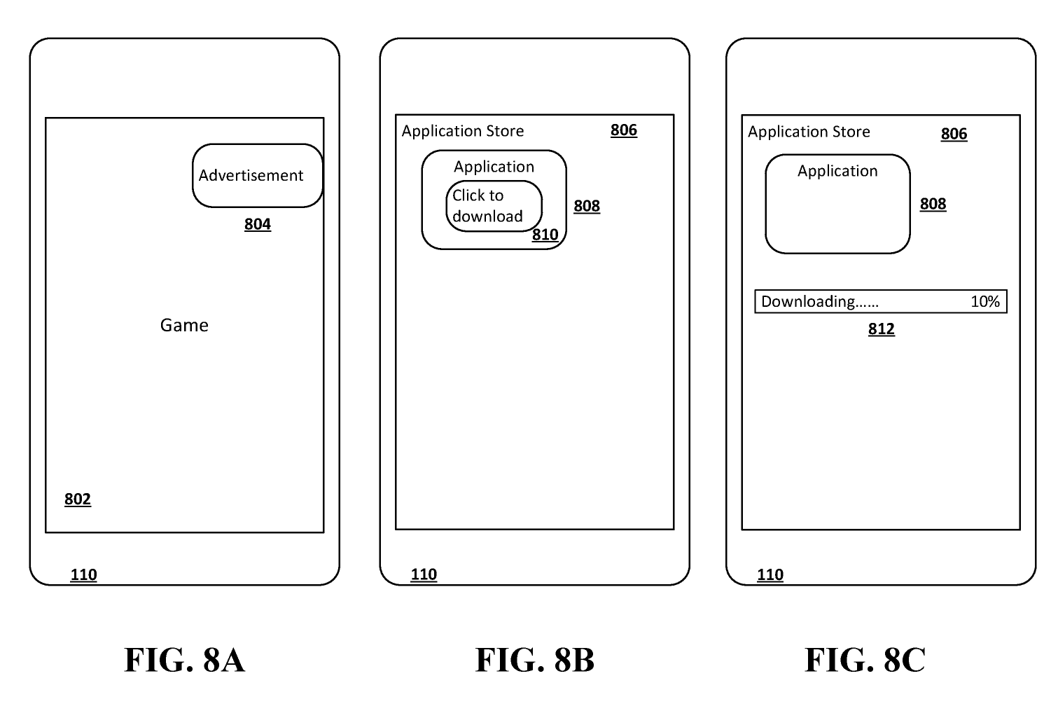

FIG. 8A shows an example of a mobile device that is running an application, such as an online game, that hosts an advertisement. In FIG. 8A, a mobile device 110 has a screen display which shows a game screen 802, which includes an online advertisement 804 for an application. The advertisement 804 may include text, graphic, video, or a combination thereof, that occupies at least a portion of the game screen 802. Some or all of the area of the online advertisement 804 may include a clickable link to the advertised application. In some implementations, the advertisement 804 may be displayed at all times during the play of the game. In other implementations, the advertisement 804 may be displayed to the user only at certain times when the game is being played. In some implementations, more than one advertisement may be displayed. For example, different advertisements for different applications may be displayed at different times during the play of the game.

When the user clicks an area of the advertisement 804 that includes a link to the advertised application, the mobile device 110 opens an application store 806 which displays an application installation icon 808 for the advertised application, as shown in FIG. 8B. The application installation icon 808 may include a clickable link 810 which allows the user to click to initiate downloading of the application. In some implementations, some or all of the area of the application installation icon 808 may be clickable. In some implementations, the advertisement 804 may include links to more than one advertised application, and icons (not shown) for more than one application may be displayed in the application store 806. After the user clicks the link 810 to download the selected application 808 in FIG. 8B, the mobile device 110 may show the process of downloading, and optionally, the percentage of the application that has been downloaded at a given time, in area 812 of the screen, as shown in FIG. 8C.

More generally, in situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. As another example, although the identity of the device may be monitored for multiple repeated playbacks of online audio or video content, personal information associated with the user of that device may not be necessary for a system to compile histories or statistics of legitimate or inflated playbacks of online audio or video content on that particular device. Thus, the user may have control over how information is collected about the user and used by a system as disclosed herein.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method of providing an application in response to selection of a media item on a user device, the method comprising:
prior to receiving a request from the user device to download an application, preparing, by a media content serving platform, application installation information of an application associated with the media item, the application installation information comprising information selected from the group consisting of an application installation page and application installation metadata; and
transmitting, by the media content serving platform, the application installation information to an application distribution platform, to cause the application distribution platform to make the application installation information available for the user device to download the application prior to receiving the request from the user device to download the application.

2. The method of claim 1, wherein preparing, by the media content serving platform, the application installation information comprises:
determining, by the media content serving platform, a probability that a user is interested in the media item among a plurality of media items; and
selecting, by the media content serving platform, the media item based on the probability that the user is interested in the media item.

3. The method of claim 2, further comprising:
making, by the application distribution platform, the application installation information available for the user device to download the application;
detecting, by the application distribution platform, the request to download the application; and
transmitting, by the application distribution platform, the application to the user device upon detecting the request to download the application.

4. The method of claim 3, wherein making, by the application distribution platform, the application installation information available for the user device to download the application comprises pre-storing, by the application distribution platform, the application installation information of the application associated with the media item prior to receiving the request from the user device to download the application.

5. The method of claim 4, wherein pre-storing, by the application distribution platform, the application installation information of the application associated with the media item comprises pre-caching, by the application distribution platform, the application installation information of the application associated with the media item.

6. The method of claim 3, wherein making, by the application distribution platform, the application installation information available for the user device to download the application comprises:
detecting, by the application distribution platform, a signal that indicates that the media item is being displayed on the user device; and
receiving, by the application distribution platform, the application installation information from the media content serving platform.

7. The method of claim 6, further comprising:
running, by the user device, a host application that includes the media item;
displaying, by the user device, the media item; and
transmitting, by the user device, the signal to the application distribution platform.

8. The method of claim 1, wherein preparing, by the media content serving platform, the application installation information comprises:
creating, by the media content serving platform, a cryptographically signed bundle which includes application installation metadata of one or more applications associated with one or more media items; and
transmitting, by the media content serving platform, the cryptographically signed bundle to the application distribution platform.

9. The method of claim 8, further comprising:
unpacking and decrypting, by the application distribution platform, the cryptographically signed bundle to generate an unpacked and decrypted bundle; and
retrieving, by the application distribution platform, the application installation metadata of the one or more applications from the unpacked and decrypted bundle.

10. The method of claim 1, wherein the media content serving platform comprises an advertisement serving platform.

11. An apparatus for providing an application in response to selection of a media item on a user device, the apparatus comprising:
a memory; and
a processor communicably coupled to the memory, the processor configured to execute instructions to:
prepare application installation information of an application associated with the media item, the application installation information comprising information selected from the group consisting of an application installation page and application installation metadata, prior to receiving a request from the user device to download an application; and
transmit the application installation information to an application distribution platform, to cause the application distribution platform to make the application installation information available for the user device to download the application prior to receiving the request from the user device to download the application.

12. The apparatus of claim 11, wherein the instructions to prepare the application installation information include instructions to:
determine a probability that a user is interested in the media item among a plurality of media items; and
select the media item based on the probability that the user is interested in the media item, to cause the application distribution platform to pre-store the application installation information of the application associated with the media item prior to receiving the request from the user device to download the application.

13. The apparatus of claim 11, wherein the instructions to transmit the application installation information to the application distribution platform, when executed, cause the application distribution platform to:
make the application installation information available for the user device to download the application;
detect the request to download the application; and
transmit the application to the user device upon detecting the request to download the application.

14. The apparatus of claim 11, wherein the application distribution platform is configured to:
detect a signal that indicates that the media item is being displayed on the user device; and
receive the application installation information from the media content serving platform.

15. The apparatus of claim 11, wherein the instructions to prepare the application installation information include instructions to:
create a cryptographically signed bundle which includes application installation metadata of one or more applications associated with one or more media items; and
transmit the cryptographically signed bundle to the application distribution platform.

16. An apparatus for providing an application in response to selection of a media item on a user device, the apparatus comprising:
an application distribution platform; and
a media content serving platform communicably coupled to the application distribution platform, the media content serving platform configured to:
prepare application installation information of an application associated with the media item, the application installation information comprising information selected from the group consisting of an application installation page and application installation metadata, prior to receiving a request from the user device to download an application; and
transmit the application installation information to the application distribution platform, to cause the application distribution platform to make the application installation information available for the user device to download the application prior to receiving the request from the user device to download the application.

17. The apparatus of claim 16, wherein the media content serving platform is configured to:
determine a probability that a user is interested in the media item among a plurality of media items; and
select the media item based on the probability that the user is interested in the media item, and
wherein the application distribution platform is configured to:
pre-store the application installation information of the application associated with the media item prior to receiving the request from the user device to download the application.

18. The apparatus of claim 16, wherein the application distribution platform is configured to:
make the application installation information available for the user device to download the application;
detect the request to download the application; and
transmit the application to the user device upon detecting the request to download the application.

19. The apparatus of claim 16, wherein the application distribution platform is configured to:
detect a signal that indicates that the media item is being displayed on the user device; and
receive the application installation information from the media content serving platform.

20. The apparatus of claim 16, wherein the media content serving platform is configured to:
create a cryptographically signed bundle which includes application installation metadata of one or more applications associated with one or more media items; and
transmit the cryptographically signed bundle to the application distribution platform.
